(19) United States
(12) Patent Application Publication
(10) Pub. No.: US 2016/0148765 A1
(43) Pub. Date: May 26, 2016

(54) OPERATOR CONTROL DEVICE FOR AN ELECTRICAL APPLIANCE AND ELECTRICAL APPLIANCE

(71) Applicant: E.G.O. Elektro-Geraetebau GmbH, Oberderdingen (DE)

(72) Inventors: Uwe Ungethuem, Spreenhagen (DE); Henry Kuehn, Hohen Neuendorf (DE); Frank Graff, Radensleben (DE); Michael Gaertner, Berlin (DE)

(21) Appl. No.: 14/951,243

(22) Filed: Nov. 24, 2015

(30) Foreign Application Priority Data
Nov. 25, 2014 (DE) 10 2014 224 052.2
Feb. 24, 2015 (DE) 10 2015 203 291.4

(51) Int. Cl. H01H 19/58; H01H 19/02; H01H 19/11

(52) U.S. Cl. CPC H01H 19/585; H01H 19/11; H01H 19/025; H01H 2219/062; H01H 2219/034; H01H 2231/012; H01H 2235/01

(57) ABSTRACT

An operator control device for an electrical appliance has a cover, a rotary actuator as an actuating element and a mount for the rotary actuator. The rotary actuator is arranged under the cover and has a driver disk with contacts, and a component carrier with opposing contacts. The contacts bear against the opposing contacts or conductor tracks as a function of a rotational position. The mount has a mounting frame with an axle which is rotatably mounted thereon for the rotary actuator, which axle penetrates the driver disk, the component carrier and the cover. The axle has an outer contour and the driver disk has an inner contour which corresponds thereto and is rotationally fixed with respect to the outer contour, wherein the driver disk and the axle are arranged so as to be rotationally fixed with respect to one another but axially movable.

### CROSS-REFERENCE TO RELATED APPLICATIONS

This application claims priority to German Application No. 10 2014 224 052.2, filed Nov. 25, 2014 and German Application No. 10 2015 203 291.4, filed Feb. 24, 2015, the contents of both of which are hereby incorporated herein in their entirety by reference.

### TECHNICAL FIELD

The invention relates to an operator control device for an electrical appliance and to an electrical appliance which is provided with such an operator control device.

### BACKGROUND

In electrical appliances such as electric cookers, rotary knobs and rotary actuators of an operator control device are usually arranged on the front side of a kitchen unit, while the associated hob, which can be operated with the rotary actuators, is arranged on the upper side.

For autonomous hobs, it is possible to provide rotary actuators of an operator control device whose axle projects through a cover of the operator control device which corresponds in this case to the hob plate of the hob. A rotary knob or some other handle by means of which the rotary actuator can be rotated are plugged onto the axle at the top. The mounting and sealing of such a rotary actuator presents numerous problems.

### BRIEF SUMMARY

The invention is based on the problem of providing an operator control device which is mentioned at the beginning and an electrical appliance which is provided therewith and with which problems from the prior art can be avoided and with which, in particular, it is possible to design the operator control device together with the rotary actuator in a mounting-friendly fashion and operator-control-friendly fashion and to fix it to the electrical appliance.

This problem is solved by means of an operator control device and by means of an electrical appliance which is provided therewith. Advantageous and preferred refinements of the invention are the subject matter of the further claims and are explained in more detail below. In this context, many of the features are specified or described only for the operator control device or only for the electrical appliance. However, independently of this they are intended to be able to apply both to the operator control device and to the electrical appliance independently. The wording of the claims is made into the content of the description by express reference.

There is provision that the operator control device has a cover, a rotary actuator as a switching element, a switch or an actuating element and a mount for the rotary actuator. The cover can be an advantageously flat surface here, and the cover is particularly advantageously one side or outer face of the electrical appliance, for example a hob plate when the electrical appliance is a hob.

In the further design of an operator control device according to the invention, the rotary actuator is arranged under the cover. In the text which follows, the rotary actuator is referred to even if the operator control device has a switch or a switching element or an actuating element. Such a rotary actuator is known per se, for example from DE 102004004016 A1, DE 102005021890 A1 or DE 10338263 A1. It can have discrete rotational positions as switch positions with specific functions. Alternatively or additionally, a variable which can be continually adjusted for the rotational travel, such as, for example, a power stage or a running time of a timer, can be set for a type of code actuator or gray code actuator.

The rotary actuator has a driver disk which is rotatably mounted. This driver disk in turn has contacts or sliding contacts. Furthermore, the rotary actuator has a component carrier, in particular a printed circuit board, on which opposing contacts or conductor tracks are provided. The contacts or the sliding contacts of the driver disk bear against the opposing contacts or conductor tracks of the component carrier depending on the rotational position and, as a function thereof bring about setting of specific switching functions or adjustment of specific values.

Furthermore, the operator control device is constructed with a mount which has a mounting frame with an axle, rotatably mounted thereon, for the rotary actuator. The axle penetrates the driver disk and the component carrier and projects into an opening in the cover. The axle can protrude via the cover, but does not necessarily have to do so. However, for improved mounting, the axle should project at least into the cover or the corresponding opening therein. The axle has a specific outer contour, for example in the manner of a polygon or a toothing arrangement. The driver disk has an inner contour which corresponds to the latter and is rotationally fixed with respect to the outer contour when the outer contour is fitted into the inner contour. The driver disk and the axle are therefore arranged so as to be rotationally fixed with respect to one another, wherein they can still be moved axially.

As a result it is possible for the axle to be in a position which is relatively unsusceptible to faults or is dimensionally tolerant with respect to the position of the driver disk in the axial direction. Since the handle or the rotary knob is attached to the axle, the axle has to be designed to absorb specific forces. It is therefore considered advantageous if these forces can be kept away from the driver disk at least in the axial direction. The specified axial mobility of the two components with respect to one another actually serves this purpose, while any change in the rotational position of the axle owing to an operator control prespecification as a result of the outer contours and inner contours engaging one in the other in a rotationally fixed fashion can be detected as a change in the rotational position of the driver disk, with a resulting adjustment function or switching function. A specified toothed embodiment of the outer contour and inner contour is in fact considered to be advantageous. This makes rotational securement, even with different axial relative positions as well as even during an axial movement, easily possible. In one advantageous embodiment of the invention, the outer contour and inner contour can be designed in such a way that they can be assembled, or can engage with one another, only in a single, precisely prescribed rotational position. This makes it possible to avoid mounting errors easily.

In one embodiment of the invention, a flat and/or planar carrier, which can be, for example, a carrying plate or a supporting structure, can be arranged under the mounting frame and under the driver disk in order to support thereon functional units of the electrical appliance such as, for example, heating devices in the form of induction coils or else also the specified operator control device or the rotary actuator. In an extension of the axle, a bearing recess, advantageously a round or circular bearing recess, is provided in the carrier. A bearing projection, which is concentric with respect to the axle, and under certain circumstances even formed by the axle if the latter penetrates the driver disk, is provided on the underside of the driver disk. The bearing projection is arranged so as to correspond to the bearing recess and so as to be rotatably therein in such a way that they both together form a rotary bearing. As is advantageously and customary in the case of a rotary bearing, this rotary bearing will have play in the radial direction only to such an extent that the bearing projection can easily be rotated in the bearing recess or the rotary actuator as a whole can easily be rotated.

By means of the abovementioned rotary bearing it is possible for the rotary actuator to be mounted with its axle not only by means of the driver disk but also by means of the component carrier or the printed circuit board to prevent tilting or lateral displacement but also additionally by means of the rotary bearing on the flat or planar carrier. In particular, this carrier is designed in a stable fashion, in particular as a carrying plate as mentioned above or as a supporting structure for the further functional units, it can be considered to be designed in a very stable fashion and therefore form a very stable bearing to prevent lateral displacement and tilting. A cover of the operator control device also constitutes a type of rotary bearing for the axle of the rotary actuator, wherein the cover is provided in the upper region of the axle and therefore above the driver disk, so that a rotary bearing is provided both above the driver disk and under the driver disk. This brings about a high level of stability preventing tilting and lateral displacement.

The bearing projection runs advantageously within the carrier and is shorter than the depth of the bearing recess. The bearing projection particularly advantageously does not protrude over the underside of the carrier, with the result that the structure which is usually provided under the carrier cannot be adversely affected and does not have to be changed. If the bearing projection does not have to be changed. If the bearing projection is thick and is therefore stable enough and the carrier also, relatively brief plugging into the bearing recess is sufficient. The carrier can be, for example, 1 mm to 3 mm thick. The bearing projection can have a diameter corresponding to approximately the diameter of the axle, advantageously 3 mm to 8 mm. As a result of the application of the lateral force to the bearing recess, the stability of even a rather thin carrier is sufficient, and given the diameters of the bearing projection mentioned by way of example the latter is also stable enough.

As indicated above, the carrier is advantageously designed to carry functional units of the electrical appliance. In this context, in the case of an induction hob it can carry the induction coils as an electrical appliance, as is usually implemented there with a carrying plate. Alternatively or additionally, the carrier can carry functional units such as a plurality of the inventive rotary actuators or operator control devices. The carrier can be a plate, that is to say can be composed of metal, but it can also be composed of plastic.

The mounting frame advantageously rests at least partially on the carrier or is even attached thereto, advantageously releasable attached. In this context, the mounting frame can rest on the carrier in a largely planar fashion. It is therefore well supported.

In order to attach the mounting frame to the carrier, mounting projections, for example two to four or six mounting projections, can be formed around the bearing recess in the carrier. The mounting projections can protrude upward over the upper side of the carrier in order to avoid adversely affecting the structure of the electrical appliance located thereunder. Mounting noses are advantageously provided on the mounting frame and are designed to engage under the mounting projections. Here, it is also possible within the scope of the invention to embody the mounting noses on the carrier and to embody the mounting projections on the mounting frame. Advantageously at least two mounting projections, and particularly advantageously all the mounting projections, are at the same distance from the bearing recess. Correspondingly, all the mounting noses can advantageously be at the same distance from the axle on the mounting frame. It can therefore be possible that no displacement along a line or a straight line is carried out as a movement, which would have the problem that the bearing projection would, of course, have to engage in the bearing recess. Instead, in order to attach the mounting frame to the carrier, the mounting frame can then be fitted onto the carrier in a fitting position in such a way that the bearing projection is plugged into the bearing recess. Then, by slightly rotating the two parts with respect to one another the mounting noses can be made to engage under the mounting projections. In this context, a small rotational angle of 5° to 30° can be sufficient. The connection to the mounting noses and mounting projections must, owing to the function of the rotary bearing, actually only ensure that the mounting frame cannot be lifted off from the carrier, in order to prevent lateral displacement.

In order to fit the mounting frame more easily onto the carrier with engagement of the bearing projection in the bearing recess, which is, of course, intended to be a relatively tight fit, it can be provided that at least one elongate hole, which advantageously has a bent shape, is provided in the carrier. Bending of such a bent elongate hole can correspond to a circular line with the axle or the bearing recess as a center point, and the elongate holes should therefore run around the bearing recess in the manner of a circular section. At least two or three such elongate holes are particularly advantageously provided. A downwardly extending guide pin, which engages in the corresponding elongate hole when the mounting frame is positioned on the carrier, is provided for each elongate hole on the mounting frame. As a result of these plurality of elongate holes in addition to the rotary bearing, positionally accurate fitting of the mounting frame on the carrier in the fitting position can be made easier. As a result of the bent shape of the elongate holes, a guide pin can run along in the elongate holes during rotation of the mounting frame for the production of the connection in that, therefore, the mounting noses engage under the mounting projections. These elongate holes can form an additional means of securement to prevent displacement of the mounting frame and carrier with respect to one another in the lateral direction.

In order to prevent the mounting frame from rotating back with respect to the carrier, during which the abovementioned connection could possibly be released, it is possible to provide that either the connection of the mounting noses and the mounting projections prevents this. The mounting noses could therefore engage with undercuts behind the mounting projections, for example, which prevent automatic release or rotating back. Alternatively it is possible to provide at least one securing recess in the region of the mounting frame or underneath the mounting frame in the carrier. A downwardly projecting and sprung securing projection is then formed on the mounting frame itself. The securing projection engages in the securing recess only in the end position of the mounting frame on the carrier, that is to say after mounting has occurred, and in the process the securing projection forms a positively locking anti-rotation means to prevent rotating back. Alternatively, a sprung securing projection which protrudes in the direction of the mounting frame and which engages in a securing recess in the mounting frame in the end position can be provided in the carrier. In this end position, the anti-rotation means should basically be releasable again, for example by virtue of the fact that the securing projection can be reached, for example with a tool such as a narrow screwdriver, and can be pressed or lifted or bent out of the securing recess. After the anti-rotation means has been released, the mounting frame can be rotated back with respect to the carrier in order to release the connection and remove the mounting frame, for example for repair purposes.

An anti-rotation means is therefore formed which is automatically formed during the mounting of the mounting frame on the carrier by fitting and rotating.

In one advantageous embodiment of the invention, the component carrier is a printed circuit board. In particular, the component carrier or the printed circuit board has opposing contacts or conductor tracks on the side facing the driver disk. These opposing contacts or conductor tracks should correspond in accordance with a movement path or rotational path of the contacts or sliding contacts of the driver disk during its movement by rotation of the rotary actuator. However, this is known per se to a person skilled in the art, in particular from the abovementioned code switches. In this context, the driver disk itself is advantageously not even in electrical contact on the outside. Instead, the contacts or sliding contacts form an electrical contact between the opposing contacts or conductor tracks on the component carrier. For this purpose, the contacts or sliding contacts can be provided on elongate and sprung contact arms or can be formed by the latter, these being attached to the driver disk, for example by plugging or plastic welding.

In one embodiment of the invention, at least one lighting means is provided on the component carrier. The lighting means is intended to illuminate upward in the direction of the cover and to illuminate through the cover, which is then advantageously at least translucent. In order to configure this illumination in a defined fashion, at least one lightguide element or a light duct element can be arranged between the component carrier and the cover. A lightguide element or one light duct element can have at least one laterally outwardly closed light duct which is arranged above the lighting means. Therefore, even when the lighting means radiate over a large surface the lighting effect or the through-lighting of the cover can be bounded in a relatively sharp fashion over a small surface. This can be used to display specific information. A light duct element advantageously has a plurality of light ducts for a plurality of lighting means on the component carrier. The lighting means can particularly advantageously surround the axle and therefore form displays for different rotational positions, for example as functions to be selected or as functions which are set.

In one advantageous embodiment of the invention, means for representing symbols by through-lighting by means of the at least one lighting means are arranged on the light duct element. These means may be, for example, cutouts in the form of symbols and/or with colored cutouts. It is therefore possible to display a symbol, possibly even a colored symbol, with an undefined light appearance or through-lighting in a manner known per se. In this context, the cutouts can be provided on a single coherent part which is advantageously designed separately from the light duct element. Both parts can be formed essentially in a flat and disk-like fashion. Such a symbol disk is advantageously arranged above the light duct element, particularly advantageously directly on its upper side, wherein at the same time it can also bear against the underside of the cover. Both parts can, under certain circumstances, also be manufactured as one part or as a structural unit, in particular by multi-component plastification molding.

The rotary actuator and/or the driver disk can be pressed in the direction of the cover and/or the component carrier, preferably in a sprung fashion or by means of spring force. Since the driver disk interacts with the component carrier for the switching function or the actuating function, these two parts should have a defined position with respect to one another, for which purpose the spring force can serve. Furthermore, the spring force can alternatively or additionally serve to press the unit of the driver disk and component carrier against the cover in order to form a defined abutment there. For the spring force spring means are advantageously provided which are arranged between the plane of the driver disk, on the one hand, and the mounting frame, on the other. The spring means can in principal be designed in a variety of ways, they are advantageously spring means or helical springs which are turned in the form of a screw. An alternative would be voluminous plastic bodies which, however, are less advantageous here. The spring means are especially advantageously metal springs or have metal springs. The plurality of spring means or a plurality of helical springs are advantageously provided in order to generate an essentially uniform spring force which can press the rotary actuator and/or the driver disk in the direction of the cover or of the component carrier.

In one advantageous embodiment of the invention, a rotary actuator cover is provided for the rotary actuator, specifically downward in the direction of the mounting frame or under the driver disk. This rotary actuator cover is intended to form part of a housing of the rotary actuator, wherein the driver disk is arranged in this housing. This rotary actuator cover is particularly advantageously largely or to a certain extent flat and can have approximately the outer contour and size of the component carrier. More particularly, the rotary actuator cover can be connected mechanically to the component carrier and then forms a structural unit which has a rotary actuator housing and the essential functional units of the rotary actuator, specifically the driver disk with the contacts or sliding contacts and also the opposing contacts or conductor tracks. Furthermore, the axle of the rotary actuator runs through this rotary actuator housing, with the result that overall the rotary actuator is produced. These two parts can be designed in a mechanically stable fashion in order therefore to provide a stable rotary actuator housing.

In one embodiment of the invention, the rotary actuator cover and component carrier can also be attached one to the other. In particular, releasable attachments are suitable for this, for example a screwed connection, on the one hand, or latch and clip connections, on the other. Even if the two parts are pressed against one another in the assembled state of the operator control device, advantageously by the spring means on the mounting frame not acting directly against the driver disk or bearing directly thereon but rather be pressed against the rotary actuator cover and pressing the latter against the cover, the rotary actuator cover and the component carrier cannot become detached from one another. Therefore, for example premounting of a structural unit in which the driver disk is arranged in the rotary actuator housing composed of the rotary actuator cover, on the one hand and the component carrier, on the other, can be provided.

In one advantageous embodiment of the invention, the operator control device has, of course, an abovementioned planar carrier under the mounting frame, wherein the mounting frame is advantageously attached to this carrier. An attachment can be achieved by means of screws and/or latching, plugging or other connections. The planar carrier can even be a carrier which does not carry only parts of the operator control device but also other functional units of the electrical appliance. It can then be used, for example, as what is referred to as a carrying plate such as is known, for example, from hobs as electrical appliances, wherein in particular heating devices have been arranged on such a carrying plate.

In a further embodiment of the invention, the rotary actuator housing can be provided with guide devices. This can also apply to the component carrier. These functional devices interact with corresponding guide devices on the mounting frame. The function of these guide devices is an anti-rotational means of the parts with respect to one another while they can be moved with respect to one another in the axial direction of the axle. Therefore, in particular none of the parts of the operator control device needs, where possible, to be attached to the underside of the cover, in particular in such a way that it cannot be detached. These guide devices can advantageously be projections or depressions in the axial direction of the rotary actuator. Here, it is generally considered sufficient if the component carrier, in particular the rotary actuator cover, is provided with guide devices in the form of protruding projections.

The axle of the rotary actuator can have an axle disk, preferably at the lower end and underneath the outer contour the axle, or the axle disk can adjoin this outer contour downward. Furthermore, the mounting frame can have mounting projections for securing the axle disk against movement in the axial direction. It is further possible for a type of closed bearing shell for the axle disk to be obtained. The mounting frame can have a rotary bearing which surrounds the axle disk and in which the axle disk is arranged. The rotary bearing ensures the rotational mobility of the axle disk, so that the rotary bearing also secures the axle disk against displacement and/or axial movement. These mounting projections do not have to cover the axle disk completely. The axle and axle disk are advantageously permanently connected to one another, in particular both fixedly in terms of rotation as well as in a generally nondetachable fashion. They are particularly advantageously manufactured in one piece, for example from plastic.

Sliding projections can be arranged on the axle disk relatively far or even at a maximum distance on the outside on an outer edge of the axle disk. These sliding projections serve to ensure that a relatively large surface of the upper side or underside of the axle disk does not bear against the rotary bearing and therefore high sliding friction does not come about. The sliding projections have here protruding or ball-like elevated portions or even projections, for example three to six or eight pieces distributed on the outside of the axle disk. The sliding projections can protrude upward or downward from the mounting disk. They can also protrude downward and then bear against the abovementioned carrier or the carrying plate.

In one advantageous embodiment of the invention, a sliding projection of the axle disk can be arranged in a sprung fashion on the axle disk in the axial direction thereof. Thus, a force effect on the axle can be absorbed better with respect to the carrier. Furthermore, forces acting when the operator control device is mounted can be absorbed better.

In one particularly advantageous embodiment of the invention, a sliding projection can be arranged in a sprung fashion on the axle disk in the axial direction in such a way that the axle disk and therefore the axle can experience only slight tipping or movement relative to the rotary actuator cover and/or the component carrier. As a result of the spring effect of the sliding projections which are mounted in a sprung fashion, there is, as it were, automatic return into the originally desired position of the axle. A spring arm which protrudes laterally from the axle disk can be provided for a sprung bearing of a sliding projection on the axle disk, wherein for a relatively large spring force in the case of thin material the spring arm should, corresponding to the axle disk, have no free end but instead, despite its elongate extent, should be arranged with both ends on the axle disk. The spring arm particularly advantageously protrudes in the plane of the axle disk, wherein the spring arm can also have the material thickness thereof with the exception of the sliding projections which protrude upward and/or downward.

The axle advantageously runs in a breakthrough through the cover, particularly advantageously the axle even protrudes somewhat above the cover. In the region of the breakthrough, a seal should be provided on the cover so that at this point liquid or dirt cannot penetrate the electrical appliance or enter under the cover and therefore into the operator control device. The seal can advantageously be designed in an overlapping fashion on the upper side of the cover, since it can engage over the latter, so to speak. In this context, the seal is, as is customary, advantageously constructed from elastic material. The seal can also have a certain height above the cover. For better attachment to the cover, the seal can also be designed in a laterally overlapping fashion in the manner of a known rubber sleeve both on the upper side of the cover and on the underside, wherein the seal overlaps to a considerably lesser degree on the underside, with the result that it can be plugged in from above through the breakthrough. Furthermore, an additional guiding means for the axle can be provided in the seal. Alternatively, a plug-on section can be provided on a rotary knob which is to be plugged onto the axle or a handle, the plug-on section being plugged onto the axle and extending through the seal, and ensuring additional centering of the axle with respect to the cover.

Further centering of the axle in the operator control device can be performed by means of a centering sleeve or an intermediate bearing which is fitted onto the axle above the outer contour and is guided near the underside of the cover, for example on the abovementioned light duct element and/or on a symbol disk above the latter.

In an advantageous embodiment of the invention the electrical appliance according to the invention is a hob and has a hob plate as a cover. The operator control device is therefore as it were an integral component of the hob by virtue of the cover, wherein the other parts of the operator control device are arranged under the cover. The operator control device can also have a plurality of such rotary actuators, wherein a plurality of axles and disks, but preferably only one rotary actuator housing and only one component carrier, should then be provided.

These and further features arise not only from the claims but also from the description and the drawings, wherein the individual features are each implemented individually or together in the form of secondary combinations in one embodiment of the invention and in other fields and can represent advantageous embodiments for which protection can be obtained per se and for which protection is claimed here. The division of the application into individual sections and intermediate headings does not limit the general applicability of the statements made under the headings.

### BRIEF DESCRIPTION OF THE SEVERAL VIEWS OF THE DRAWINGS

The exemplary embodiments of the invention are illustrated schematically in the drawings and are explained in more detail below. In the drawings:

FIG. 1 shows an exploded illustration of most of the components of an operator control device according to the invention still without a cover;

FIG. 2 shows an enlarged illustration of a cutout of parts from FIG. 1;

FIG. 3 shows the parts from FIG. 2 in partial section;

FIG. 4 shows an oblique illustration of the axle together with the axle disk and driver disk with the corresponding contours;

FIG. 5 shows a partial section through the two parts from FIG. 4 in the assembled state;

FIG. 6 shows an oblique partial section through the parts in FIG. 1 in the assembled state;

FIG. 7 shows a plan view of the sectional surface of FIG. 6 with the cover and rotary knob, on the left in the state in which it is pressed together, to the maximum extent, and on the right in the state in which it is moved apart to the maximum extent;

FIG. 8 shows an oblique view of a complete operator control device corresponding to FIG. 7, which operator control device is integrated into a hob as an electrical appliance;

FIG. 9 shows an oblique view of the operator control device which is largely assembled, similar to FIG. 6 without a carrier;

FIG. 10 shows the carrier alone in the corresponding oblique view similar to FIG. 9,

FIG. 11 shows a plan view of the operator control device from FIG. 9 fitted onto the carrier from FIG. 10 in the fitting position; and

FIG. 12 shows the arrangement from FIG. 11 rotated into the end position.

### DETAILED DESCRIPTION

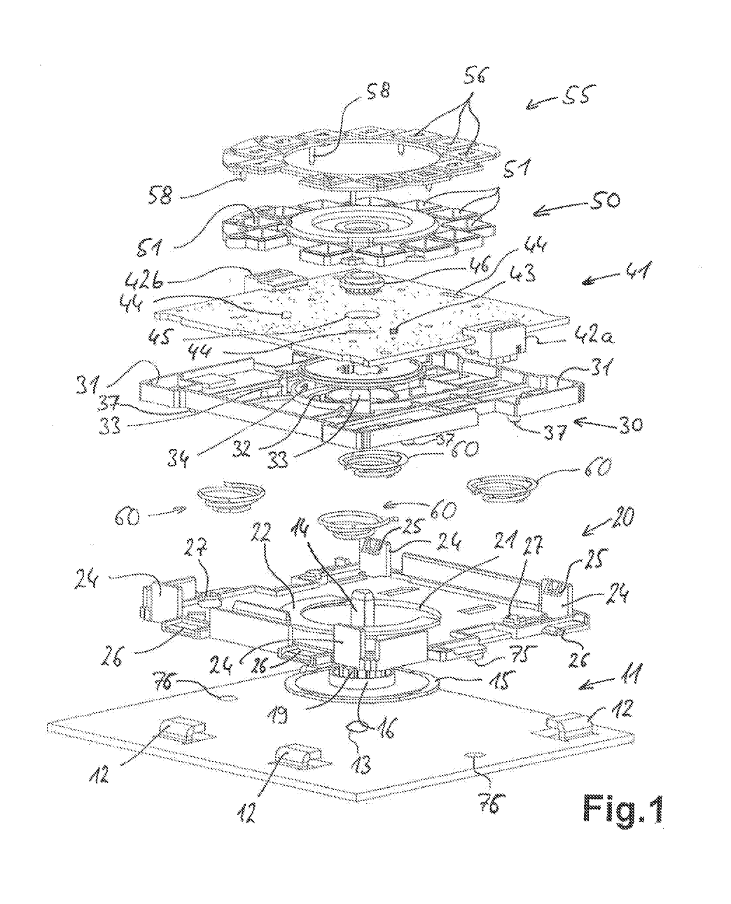

A large component of the components of the operator control device according to the invention are illustrated in an exploded illustration in FIG. 1. A carrier 11, which can advantageously be a component of a relatively large carrying plate, such as, according to the explanations given at the beginning, can be part of a hob as an electrical appliance according to the invention, is illustrated right at the bottom. The carrier 11 can then be considerably larger than is illustrated here. In this case, only a detail of the carrier 11 is then illustrated. Otherwise, the carrier 11 can be of precisely this size and can be attached to another carrying plate of this type of a hob or of another carrying device of an electrical appliance. Mounting projections 12 protrude upward from the carrier 11. The carrier 11 has an optional central bearing recess 13, which is not compulsory, as well as two securing recesses 76.

Above the latter is an axle 14 which has a flat and protruding axle disk 15 in the lower region. A circumferential guide collar 16 is integrally formed on the axle disk 15. The guide collar 16 surrounds a toothed outer contour 19, which will be explained later in more detail.

Illustrated above the latter is a mounting frame 20 with a round rotary bearing 21 for receiving the axle disk 15 therein. A partially circumferential mounting collar 22 projects beyond the rotary bearing 21 in order to mount the axle disk 15 and press it downward. The axle disk 15 and thus the axle 14, therefore mounted upward in the axial direction by the mounting collar 22 and downward by abutment on the upper side of the carrier 11, as a result of which securement against tilting is provided. Securement against lateral displacement is provided by abutment of the outer edge of the axle disk 15 against the inner edge of the rotary bearing 21.

Outwardly projecting guide projections 24, which have inwardly pointing lateral projections 25 at the end, are provided in the corner regions of the mounting frame 20. Mounting noses 26, which can be pushed under the mounting projections 12 of the carrier 11, are integrally formed on the outer edge of the mounting frame 20. Securing projections 75, which are intended to engage into the securing recesses 76 in the end position, protrude downward from two laterally protruding sprung arms. In addition to this mounting possibility, the mounting frame 20 can also be fixed to the carrier 11 by a screw connection in the end position. Finally, guides 27 for guide noses 37 are also integrally formed onto the mounting frame 20 at the bottom of the rotary actuator cover 30. The springs 60 are a combination of a spiral spring and a helical spring as what is referred to as a conical spring.

A rotary actuator cover 30 is illustrated above the mounting frame 20. The rotary actuator cover has guide openings 31 in the corner regions, through which guide openings 31 the guide projections 24 of the mounting frame 20 can engage when assembly takes place. A driver disk bearing means 32 is designed in the center of the rotary actuator cover 30. The bearing means 32 will be explained in detail below. Furthermore, three upwardly protruding latching hooks 33 are provided on the rotary actuator cover 30. The abovementioned guide noses 37 for the guides 27 are provided on the underside. They engage in said guide noses 37 in order to provide the abovementioned guidance.

Illustrated above the latter in turn is a driver disk 34 with the specified inner contour 35. This inner contour 35 fits the toothed outer contour 19 of the axle 14 or the axle disk 15 and the two fit together only in a single rotary position, as will be explained in more detail below.

Mounting points 36 are illustrated on the upper side of the driver disk 34. The abovementioned spring arms or carriers for switching and/or sliding contacts can be arranged therein, as is known from the prior art. A largely circumferential outer edge 38, which serves to provide better bearing and abutment on the underside of a printed circuit board 41 arranged above the latter, is also integrally formed on the upper side. Furthermore, the outer edge 38 ensures a certain distance of the upper side of the driver disk 34 from the underside of the printed circuit board 41, with the result that there is space here for the abovementioned contacts or sliding contacts.

Provided laterally above the latter on the printed circuit board 41 are two electrical terminals 42a and 42b, advantageously as plug-type contacts or plug-type terminals. Illustrated schematically on the upper side is an LED 43, of which in practice, of course, a plurality would be present. As an alternative to an arrangement of the LED 43 on the upper side of the printed circuit board 41, which means that a two-sided printed circuit board has to be used, they could also be arranged on the underside with an upward illumination direction and corresponding cutouts in the printed circuit board 41 so that they can also actually irradiate upward through it. Provided on the underside of the printed circuit board 41 are abovementioned opposing contacts or conductor tracks for the contacts or sliding contacts of the driver disk 34. It is not illustrated here but a person skilled in the art is familiar and can implement them. The opposing contacts are then arranged along circular paths about a feedthrough 45 or about the axle 14, likewise possibly present conductor tracks. Such an arrangement with contacts or sliding contacts and conductor tracks is known, for example, from the abovementioned DE 10338263 A1, DE 102004004016 A1 or DE 102005021890 A1, to which reference is made explicitly. Three latching openings 44, in which the latching hooks 33 of the rotary actuator cover 30 engage to bring about permanent attachment of the two parts to one another with the driver disk 34 mounted between them, are provided on the printed circuit board 41.

An intermediate bearing 46 is illustrated above the printed circuit board 41. The intermediate bearing 46 is seated, as illustrated below, in the feedthrough 45 and serves to guide and center the axle 14 in the region of the printed circuit board 41.

Illustrated above it is a light duct element 50 which is designed as a type of grid frame with a multiplicity of light ducts 51 around a center point with an opening through which the axle 14 will then extend. The light duct element 50 rests on the printed circuit board 41, specifically in such a way that the LED 43 is seated in a light duct 51, or at least the light duct 51 is arranged above a through-irradiation opening in the printed circuit board 41 with the LED under it. The light duct element 50 with the light ducts 51 has the function of allowing light displays to appear in a defined fashion.

A symbol disk 55 is provided above the light duct element 50 for such a light display. The symbol disk 55 has individual symbols 56 which can be seen better in the following illustrations. On the underside, the symbol disk 55 has mounting pins 58 with which it can be attached to the light duct element 50 and/or with the latter to the printed circuit board 41.

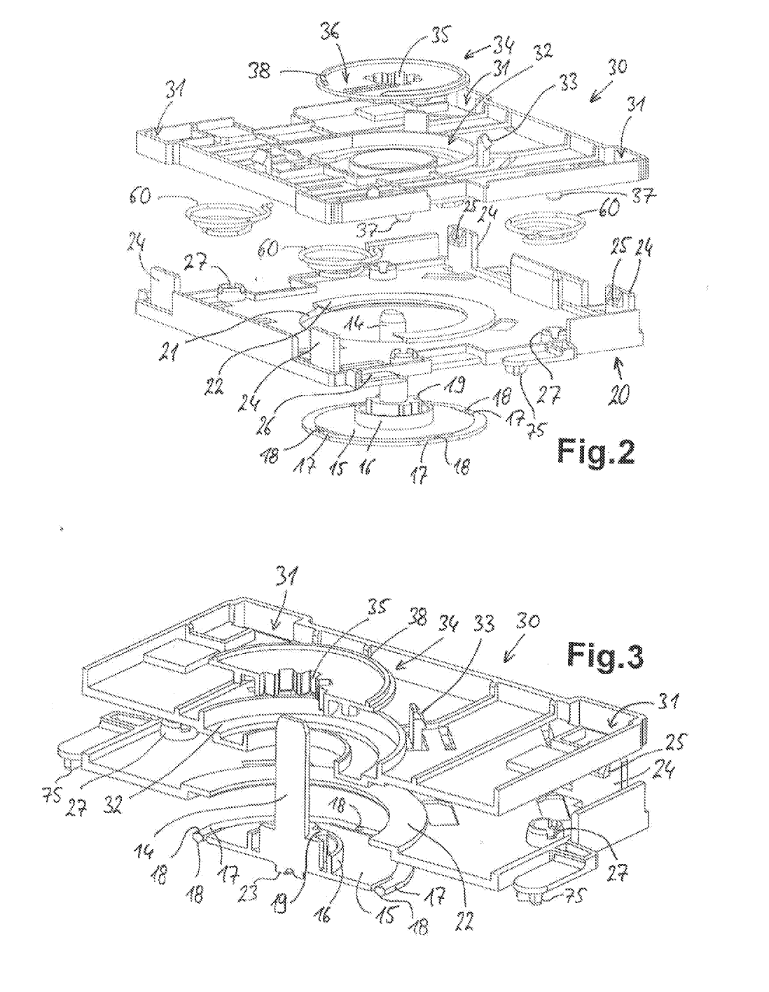

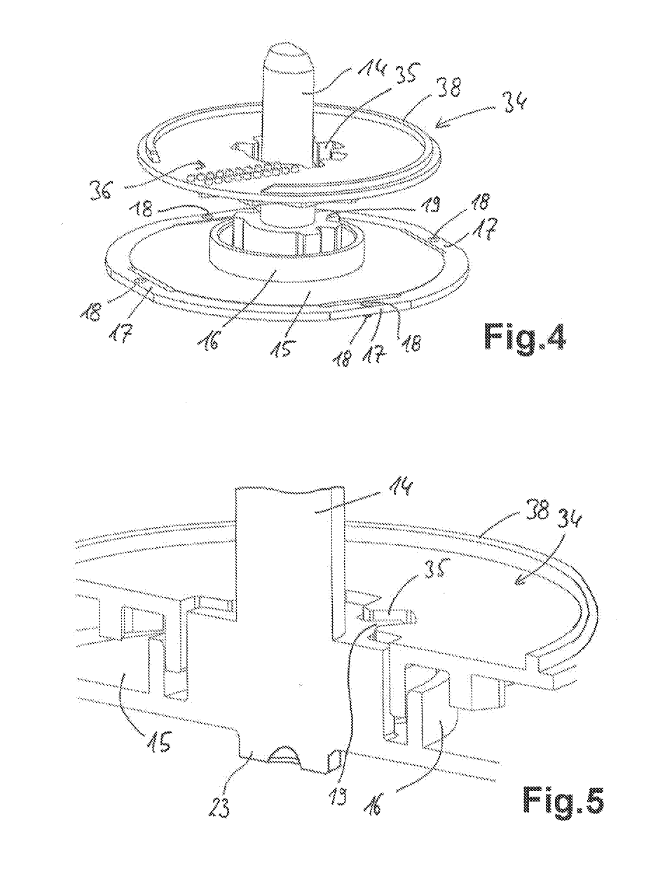

In FIG. 2, the axle 14 together with the axle disk 15, the mounting frame 20, the rotary actuator cover 30 and the driver disk 34 are illustrated moved closer together and enlarged. Furthermore, the parts are rotated through 180° about the rotational axis with respect to the illustration in FIG. 1. In a similar view, in FIG. 3 a partial section through the arrangement of FIG. 2 is illustrated, and in FIGS. 4 and 5 only the axle 14 together with the axle disk 15 and driver disk 34. The parts of the figures form essentially the abovementioned rotary actuator. On the underside of the axle disk 15, the bearing projection 23 extends downward in the extension of the axle 14, for engagement in the bearing recess 13. The length of said bearing projection corresponds approximately to the thickness of the axle disk 15.

It is apparent therefrom how the spring arms 17, which carry sliding projections 18 which point upward and downward in the center, are formed on the axle disk 15. The sliding projections 18 bring about defined sliding friction and therefore defined rotational resistance of the entire rotary actuator, since the upper sliding projection 18 bears against the underside of the mounting collar 22, and the lower sliding projection 18 bears against the upper side of the carrier 11. As a result of the construction of the spring arms 17, a spring effect, albeit a small one, to prevent tilting of the axle disk 15 is brought about with the axle 14 in this clamped-in bearing arrangement between the mounting collar 22 and the carrier 11.

It is apparent from the illustration of the toothed outer contour 19 and the correspondingly constructed inner contour, from the enlarged illustration of the toothed outer contour 19 on the axle disk 15 and the correspondingly constructed inner contour 35 of the driver disk 34, in particular with reference to FIGS. 4 and 5, that they are fixed in terms of rotation in the state in which they are plugged into one another. However, at the same time they are also axially movable by several mm, wherein they are connected to one another in a rotationally fixed fashion over its entire distance. Furthermore, it is apparent that the two parts can be plugged together only in a single position, which avoids mounting errors.

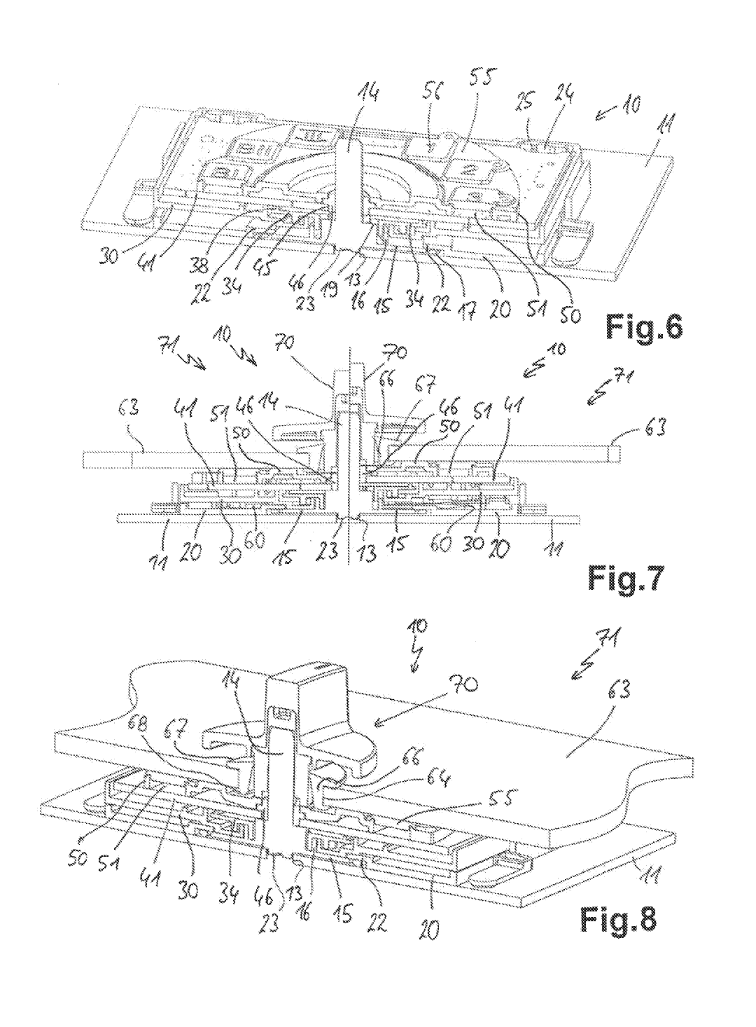

It is also apparent that the inner contour 35 of the driver disk 34 has a downwardly protruding sleeve with the same inner contour, which is in turn mounted from the outside of the guide collar 16 on the axle disk 15. The result of this is very good and precise guidance, as shown by the sectional illustrations in FIGS. 6 to 8.

From the sectional illustrations in FIGS. 6 to 8 it is also apparent that the driver disk 34 is not mounted on the rotary actuator cover 30 in the lateral direction, with the result that no forces act here. The driver disk 34 bears against the rotary actuator cover 30, in particular in the driver disk bearing arrangement 32, only in the axial direction. The bearing projection 23 engages in the bearing recess 13 as a rotary bearing, but is relatively short compared to its depth.

From FIG. 3 it is also apparent that the guide projections 24 with the latching projections 25 at the end can project through the guide openings 31 of the rotary actuator cover 30 with the result that the latching projections 25 can latch in at the bottom of the rotary actuator cover. However, the length of the guide projections 24 can be dimensioned in such a way that the rotary actuator cover 30 has specific axial movement play with respect to the mounting frame 20, that is to say can be displaced in the axial direction before it is secured by the latching projections 25. Since the printed circuit board 41 is mounted directly in the latching openings 44 by means of the latching hooks 33, in a single position on the rotary actuator cover 30, and therefore also the light duct element 50 which is attached to the printed circuit board 41 and the symbol disk 55, these parts have overall an axial but guided and limited mobility with respect to the mounting frame 20.

The rotary actuator cover 30 together with the printed circuit board 41 forms a type of rotary actuator housing for the rotary actuator corresponding to FIG. 2. It has, in particular, also the driver disk 34 with the contacts or sliding contacts, provided thereon, for opposing contacts or conductor tracks on the underside of the printed circuit board 41.

The assembled state of the parts in FIG. 1 can be seen as an operator control device 10 in FIG. 6, specifically also in the state in which they are rotated through 180°, corresponding to FIGS. 2 to 5, and also moved apart from one another to a maximum extent. From this, in particular, also from FIG. 7, as it were, the clamped-in bearing arrangement of the axle disk 15 between the mounting collar 22 of the mounting frame 30 and the upper side of the carrier 11 is apparent. Furthermore, the overall flat design can be seen. Finally, a spring 60 is illustrated which is designed as a conical spring.

It is therefore possible for the rotary actuator housing, that is to say the parts starting from the rotary actuator cover 30 in the upward direction to have in the axial direction a certain amount of movement play with respect to the mounting frame and therefore to the carrier 11, or to be displaceable, and specifically to be guided by the guides 27 together with the guide noses. A specific adaptation at a distance between the carrier 11 and a cover 63 corresponding to FIG. 8 can therefore be achieved. This distance can be influenced by the component tolerances or mounting tolerances and varied. This movement play is apparent from the two partial illustrations in FIG. 7, specifically in the state in which they are pressed together to a maximum extent on the left. On the left it is apparent that the parts, in particular the carrier 11, mounting frame 20, rotary actuator cover 30, printed circuit board 40, light duct element 50 and cover 63 can bear one on the other. The springs 60 are pressed together here.

A state in which they are not pressed together to such an extent or in which they are moved apart to a maximum extent is illustrated on the right. It is apparent that the cover 63 is somewhat higher above the carrier 11, that is to say more intermediate space is provided. The axle 14 and the mounting frame 20 are unchanged, but all the parts above them are arranged higher. The difference in height can be several mm, here, for example, 2 mm given an overall height between 10 mm and 20 mm. A limitation of the maximum travel comes from the fact that the latching projections 25 of the guide projections 24 bear against the bottom of the rotary actuator cover 30. This is the case on the right in FIG. 6 and FIG. 7.

Because of the bearing arrangement of the rotary actuator and, in particular, also because of the display by means of the LED 43, the light duct element 50 and the symbol disk 55, which should bear against the underside of the corresponding translucent cover 63, such adjustability is significant. A possible adjustment distance can be several millimeters, for example 1 mm to 5 mm. In this context, the axle 14 together with the axle disk 15 is secured at the bottom to the carrier 11 in the axial direction. The driver disk 34 can be moved with respect thereto in the axial direction, wherein the rotationally fixed bearing arrangement with respect to the axle 14 is maintained so that it is rotated in all cases. This adjustment travel can in fact be used for pressing on in a sprung fashion in an upward direction by means of a spring.

With respect to FIG. 8 it is also to be noted that although, on the one hand, the figure shows a finished operator control device 10, it also shows at the same time a detail of a hob 71. The cover 63 of the operator control device 10 is at the same time part of a hob plate of the hob 71, as is known per se. A seal 66, advantageously composed of rubber, is inserted into an opening 64 in the cover 63. The seal 66 has an upper collar 67 which is wide and rests on the upper side of the cover 63. A lower collar 68 of the seal 66 is plugged through the opening 64 and bears against the underside. This is intended to prevent liquid on the cover 63 entering between the cover itself and the seal 66 in the downward direction. Furthermore, the seal 66 has a detectable height in the upward direction above the cover 63, with the result that sloshing over of fluid is made difficult. A rotary knob 70 is designed plugged onto the axle 14, engaging over it and extending inward through the seal 66. The rotary knob 70 is designed for rotationally fixed attachment to the axle 14, to the flattened portion thereof, which is, however, basically known to a person skilled in the art. The individual symbols 56 of the symbol disk 55 with the numbers or symbols, such as are apparent, in particular, from FIG. 6, are arranged around the rotary knob 70. The numbers or symbols are translucent, with the result that the corresponding symbols or numbers can be illuminated from below with LEDs and can be perceived as a light display through the cover 63.

For the purpose of mounting, the operator control device 10 is pushed or moved linearly relative to the carrier 11, from a fitting position, so that the mounting noses 26 engage under the mounting projections 12 in the end position. In this context, the carrier 11 is bent somewhat in the region of the bearing projection 23 until the bearing projection 23 engages or latches into the bearing recess 13. Here, clearly great loading of the components occurs as a result of the bending.

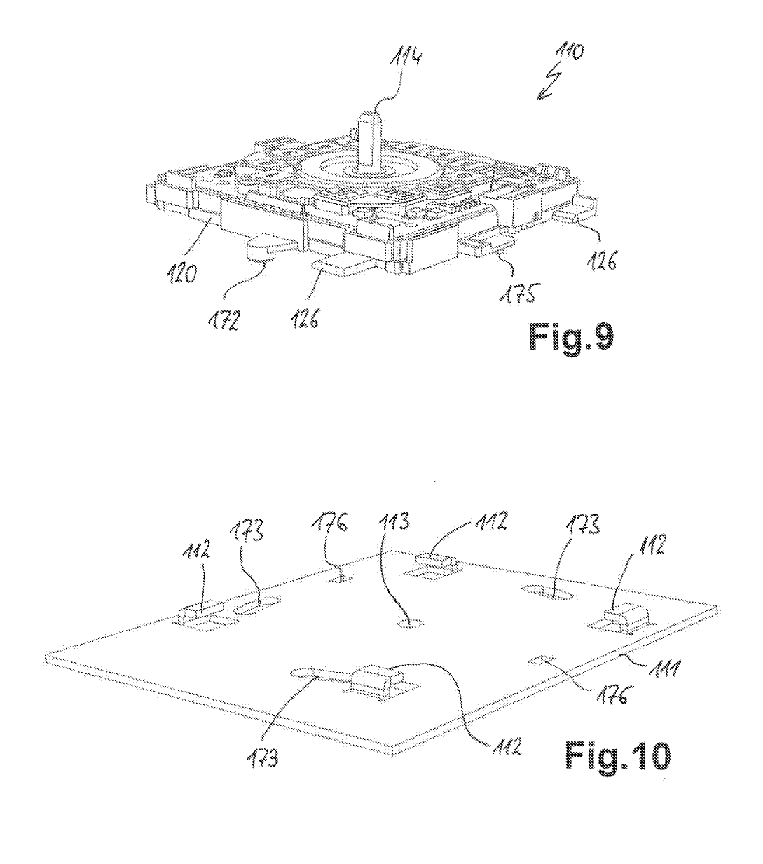

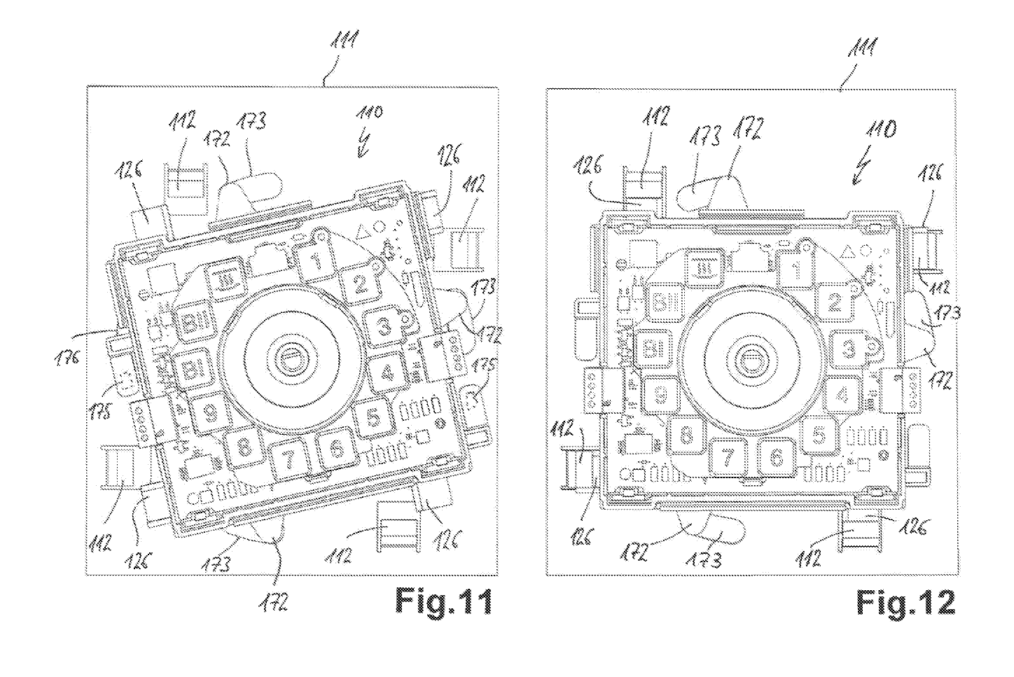

FIGS. 9 and 10 illustrate a further embodiment of an operator control device 110 in which a bearing recess 113 is also provided in the carrier 111. However, compared to the illustrations in FIGS. 5 to 8, the axle 114 has a longer bearing projection (not illustrated here), the length of which advantageously corresponds to precisely the thickness of the carrier 111. The displacement or linear movement of the operator control device 10 relative to the carrier 11 as described above is not possible with a bearing projection of such a length. For this reason, the mounting is carried out with a rotational movement, as will be explained. In turn, four mounting noses 126, which are arranged in the corner regions as in FIG. 11, are provided on the operator control device 110 or on the mounting frame 120. Furthermore, the mounting frame 120 has downwardly protruding guide pins 172 which are arranged on protruding arms. They are formed for engagement in elongate holes 173 of the carrier 111.

In order to prevent the operator control device 110 rotating again in the original direction out of the end position, securing projections 175, which protrude downward, are in turn formed on protruding arms. The securing projections 175 can be seen to be designed in a beveled fashion for the end position in the rotational direction, so that they can more easily engage in securing recesses 176 of the carrier 111.

FIG. 11 illustrates, in a plan view, how the operator control device 110 is fitted onto the carrier 111 and at the same time the bearing projection of the axle 114 engages in the bearing recess 113. In order to meet them more easily, the guide pins 172 are provided with elongate holes 173, wherein the guide pins 172 are located at the respective left-hand end of the elongate holes 173. It is apparent that in this fitting position the mounting noses 126 have not yet engaged under the mounting projections 112 in the carrier 111. Likewise, the securing projections 175 have not yet been able to be pressed into the securing recesses 176 since they are not located above them yet.

In order to mount the operator control device 110 on the carrier 111, in a second step after the fitting of the two parts to one another a relative rotation with respect to one another is then carried out, for example the operator control device 110 is rotated with respect to the carrier 111 in the clockwise direction in the illustration in FIG. 11. In this context, the guide pins 172 run along in the elongate holes 173 which are designed in a slightly bent fashion. The mounting noses 126 run under the mounting projections 112. The securing projections 175 latch into the securing recesses 176 in the end position and prevent rotating back. This rotating back is only possible by removing or breaking off the securing projections 175, or alternatively by simultaneously lifting them out of the securing recesses 176 and rotating at least to a certain extent back into the fitting position so that they do not latch in again automatically.

A lateral section of this configuration is not additionally illustrated, but it can easily be imagined with reference to FIGS. 6 and 7. Then, in fact the bearing projection on the axle 114 extends as far as the height of the underside of the carrier 111. The additional bearing arrangement of the axle 114 is therefore also made possible on the usually stable carrier 111. If the upper bearing arrangement occurs not only in the operator control device 110, in particular via the intermediate bearing 46 which is illustrated in FIG. 6, but also possibly via the seal 66 which is arranged on the cover 63, lateral forces and transverse forces on the axle 114 can be absorbed very well by these bearing points and be largely kept away from the driver disk 134.

That which is claimed:

1. An operator control device for an electrical appliance comprising:
a cover;
a rotary actuator as an switching element or as an actuating element; and
a mount for said rotary actuator, wherein:
said rotary actuator is arranged under said cover;
said rotary actuator comprises a driver disk with contacts and a component carrier with opposing contacts or conductor tracks;
said contacts bear against said opposing contacts or said conductor tracks as a function of a rotational position;
said mount comprises a mounting frame with an axle for said rotary actuator;
wherein said axle is rotatably mounted on said mounting frame and penetrates both said driver disk and said component carrier and said cover;
said axle comprises an outer contour, and said driver disk has an inner contour which corresponds to the latter and is rotationally fixed with respect to said outer contour; and
said driver disk and said axle are arranged so as to be rotationally fixed with respect to one another but are axially movable.

2. The operator control device as claimed in claim 1, wherein:
a flat and planar carrier is arranged under said mounting frame and under said driver disk, in which carrier a bearing recess is provided in extension of said axle;
a bearing projection is provided on an underside of said driver disk and concentrically with respect to said axle; and
said bearing projection is designed so as to correspond to said bearing recess and is rotatably arranged therein as a rotary bearing.

3. The operator control device as claimed in claim 2, wherein:
said bearing projection runs within said carrier or is shorter than said bearing recess is deep.

4. The operator control device as claimed in claim 3, wherein:
said bearing projection does not protrude beyond an underside of said carrier.

5. The operator control device as claimed in claim 2, wherein:
said carrier is designed for functional units of said electrical appliance as a carrying plate.

6. The operator control device as claimed in claim 5, wherein:
said mounting frame rests at least partially on said carrier and is attached thereto.

7. The operator control device as claimed in claim 2, wherein:
mounting projections are formed in said carrier around said bearing recess;
said mounting projections protrude upward beyond an upper side of said carrier; and
mounting noses for engaging under said mounting projections are formed on said mounting frame.

8. The operator control device as claimed in claim 7, wherein:
at least two mounting projections are at the same distance from said bearing recess; and
all said mounting noses on said mounting frame are at the same distance from said axle.

9. The operator control device as claimed in claim 7, wherein:
at least one elongate hole with a bent shape is provided in said carrier; and
said bend in said elongate hole corresponds to a circular line with said axle as a center point.

10. The operator control device as claimed in claim 9, wherein:
two or three of said elongate holes are provided; and
one downwardly extending guide pin is provided on said mounting frame per elongate hole in said carrier, for engaging in said corresponding elongate hole in a mounted state, in a fitting position of said mounting frame resting on said carrier, and with said bearing projection plugged into said bearing recess.

11. The operator control device as claimed in claim 2, wherein:
at least one securing recess is provided in a region close to said mounting frame in said carrier;
a downwardly protruding sprung securing projection is formed on said mounting frame; and
said securing projection engages in said securing recess and forms a positively locking anti-rotational means only when said mounting frame is in an end position on said carrier.

12. The operator control device as claimed in claim 1, wherein:
said component carrier is a printed circuit board having opposing contacts or conductor tracks which are mounted on a side facing said driver disk, corresponding to a movement path of said contacts of said driver disk when said rotary actuator rotates.

13. The operator control device as claimed in claim 1, wherein:
at least one lighting means for lighting upward in a direction of said cover or through said cover is provided on said component carrier.

14. The operator control device as claimed in claim 13, wherein:
at least one light duct element is arranged between said component carrier and said cover, said light duct element having at least one laterally outwardly enclosed light duct for arrangement above said lighting means.

15. The operator control device as claimed in claim 14, wherein:
said means for representing a symbol by through-lighting by means of said at least one lighting means are arranged on said light duct element, with at least one of cutouts in a form of symbols and with colored cutouts.

16. The operator control device as claimed in claim 15, wherein:
said cutouts are formed on a single coherent part and separately from said light duct element.

17. The operator control device as claimed in claim 1, wherein:
at least one of said rotary actuator and said driver disk are pressed by spring force in a direction of said cover or said component carrier.

18. The operator control device as claimed in claim 17, wherein:
spring means, which are arranged between a plane of said driver disk and said mounting frame, are provided for said spring force.

19. The operator control device as claimed in claim 18, wherein:
a rotary actuator cover for said rotary actuator is provided for covering said driver disk downward in a direction of said mounting frame; and
said rotary actuator cover is flat and has a shape and a size of said component carrier.

20. The operator control device as claimed in claim 18, wherein:
said spring means on said mounting frame do not act directly against said driver disk but instead are pressed against said rotary actuator cover; and
said rotary actuator cover in turn presses said driver disk and also said component carrier against said underside of said cover.

21. The operator control device as claimed in claim 20, wherein:
at least one of said rotary actuator housing and said component carrier are provided with guide devices which are designed to interact with corresponding guide devices on said mounting frame in such a way that they can be moved with respect to one another in an axial direction of said axle but are rotationally fixed with respect to one another against rotation.

22. The operator control device as claimed in claim 1, wherein:
said axle of said rotary actuator comprises an axle disk at a lower end and underneath said outer contour; and
said mounting frame comprises mounting projections for securing said axle disk against movement in an axial direction.

23. The operator control device as claimed in claim 22, wherein:
said mounting frame comprises a rotary bearing which surrounds said axle disk, and said axle disk is surrounded by said rotary bearing so as to be rotatable and is secured against displacement or axial movement.

24. The operator control device as claimed in claim 2, wherein:
sliding projections which are positioned in an upward direction against said mounting projections are arranged on said axle disk; and
sliding projections are also provided which are positioned in a downward direction against said carrier.

25. The operator control device as claimed in claim 24, wherein:
said sliding projection is arranged in an axial direction in a sprung fashion on said axle disk against a spring arm protruding laterally from said axle disk.

26. The operator control device as claimed in claim 1, wherein:
said axle runs in a breakthrough through said cover and a seal is provided on said cover in a region of said breakthrough.

27. The operator control device as claimed in claim 26, wherein:
said seal is designed overlapping laterally on an upper side of said cover.

28. An electrical appliance having an operator control device according to claim 2, wherein:
said electrical appliance comprises a hob with a hob plate as a cover; and
said hob is provided with, on an underside of said hob plate, an essentially enclosed carrying plate as a carrier, to which said mounting frame is attached.
